(19) United States
(12) Patent Application Publication
(10) Pub. No.: US 2014/0351521 A1
(43) Pub. Date: Nov. 27, 2014

(54) STORAGE SYSTEM AND METHOD FOR CONTROLLING STORAGE SYSTEM

(71) Applicants: Shintaro Kudo, Yokohama (JP); Akira Yamamoto, Sagamihara (JP); Yusuke Nonaka, Kawasaki (JP); Sadahiro Sugimoto, Kawasaki (JP)

(72) Inventors: Shintaro Kudo, Yokohama (JP); Akira Yamamoto, Sagamihara (JP); Yusuke Nonaka, Kawasaki (JP); Sadahiro Sugimoto, Kawasaki (JP)

(21) Appl. No.: 14/342,848

(22) PCT Filed: May 27, 2013
(86) PCT No.: PCT/JP2013/064573

§ 371 Date: Mar. 5, 2014

(51) Int. Cl. G06F 12/08

(52) U.S. Cl. CPC G06F 12/0868
USPC 711/125

(57) ABSTRACT

A cache package (for example, a flash memory package configured by flash memories) can execute a cache control process instead of a processor in a storage system by a request of the cache control process from the storage system. Consequently, time for the process that the processor of the storage system executes can be reduced and increase in a throughput can be achieved. For example, particularly the present invention is effective in real time data processing in OLTP (OnLine Transaction Processing) (for example, database processes in finance, medical service, Internet service, and government and public service). In addition, under the concept of recent EPR (Enterprise Resource Planning) a flexible storage system that can respond rapid fluctuation in an amount of data and an access load can be established and leveraged by increasing several boards of required cache packages.

### BACKGROUND

The present invention relates to a storage system, and particularly relates to a cache function provided by the storage system.

Recently, an amount of data stored in a memory device has been steadily increased. Therefore, read/write of data is more frequently carried out than ever. As a result, problems of increasing process time of a processor in a storage system and reducing throughput of the whole system are arisen. Business environments and IT systems has been rapidly changed, and therefore, a flexible storage system that can respond to rapid fluctuation of the data amounts and access loads and meets a price is required based on a concept of ERP (Enterprise Resource Planning).

A technology in which, in a storage system, memories such as DRAM that is faster than a storage device such as a magnetic disk are installed and, to a read request of the data from a host computer, data read from the storage device is temporally stored (cached) and the storage system rapidly responds to the host computer when the read request for the same data is received again, as described in Japanese Unexamined Patent application Publication No. Hei10(1998)-269695, has been known. Similarly, a technology in which, to a write request of data from the host computer, data is cached in a memory and the storage system rapidly responds to the host computer without waiting to write in the memory device has been known. By these technologies, a throughput of the whole system can be improved compared with direct read/write to the storage device. For example, in the case of DRAM, however, a large amount of DRAM is difficult to install in the storage system in the present circumstances because a price of DRAM is high.

### SUMMARY

In a process based on an access request to the storage device (for example, a read/write request), a cache control process (for example, a Hit/Miss determination process, which determines whether data is cached in a memory or not; an update process of management information of correspondence relation between user data with cache and a cache area; and an update process of a queue for controlling release order of the cache area) has a large proportion and other processes cannot be executed during completion of the process when a processor in the storage system executes a certain cache control process. As a result, reduction in the throughput of the storage system is caused.

The present invention includes a storage device including a cache package and the storage device separately stores management information in a control memory in the storage system and a package memory in a cache package so that control target segments are stored in a single cache package in the cache control process. On these bases, the processor of the cache package is made to execute the cache control process by linking the processor included in the cache package and the processor included in the storage system.

According to the present invention, performance of the storage system can be improved by reducing time required for cache control of the processor in the storage system when caching of data is carried out.

### BRIEF DESCRIPTION OF THE DRAWINGS

FIG. 1 is a view illustrating a configuration of a storage system in an embodiment;

FIG. 2 is a view illustrating a logical configuration of a microprogram and control information in a control memory in the embodiment;

FIG. 3 is a view illustrating a configuration of a flash memory package (FMPK) in the embodiment;

FIG. 4 is a view illustrating a logical configuration of an FMPK control program in the embodiment;

FIG. 5 is a view illustrating a relation between a cache directory of DRAM and SGCB (Segment Control Block) in the embodiment;

FIG. 6 in a view illustrating a relation between a cache directory of FMPK and SGCB in the embodiment;

FIG. 7 is a view illustrating SGCB in the embodiment;

FIG. 8 is a view schematically illustrating a relation between a logical space and a physical space of FMPK in the embodiment;

FIG. 9 is a view illustrating a logical address-physical address conversion table in the embodiment;

FIG. 10 is a view illustrating a cache directory in FMPK in the embodiment;

FIG. 11 is a view illustrating a clean queue and a dirty queue in the embodiment;

FIG. 12 is a view illustrating a free queue for DRAM and free queue for FMPK in the embodiment;

FIG. 13 is a view illustrating a communication method when a process to FMPK is requested in the embodiment;

FIG. 14 is a view illustrating an example of a request message in the embodiment;

FIG. 15 is a view illustrating an example of a response message in the embodiment;

FIG. 16 is a flowchart of a process in which the storage system determines the cache package in an allocated location in the embodiment;

FIG. 17 is a view illustrating an allocated location cache package determination table in the embodiment;

FIG. 18 is a view illustrating an FMPK load information table in the embodiment;

FIG. 19 is a flowchart of an allocated location FMPK change process in the embodiment;

FIG. 20 is a flowchart of a read process in the embodiment;

FIG. 21 is a view schematically illustrating the read process in the embodiment;

FIG. 22 is a flowchart of a read process for DRAM in the embodiment;

FIG. 23 is a flowchart of a free segment securement for FMPK and segment allocation process in the embodiment;

FIG. 24 is a flowchart of free segment securement process for DRAM in the embodiment;

FIG. 25 is a flowchart of a write process in the embodiment;

FIG. 26 is a view schematically illustrating the write process in the embodiment;

FIG. 27 is a flowchart of a write process for DRAM in the embodiment;

FIG. 28 is a flowchart of a destage process in the embodiment;

FIG. 29 is a flowchart of a Hit/Miss determination process in the embodiment;

FIG. 30 is a view illustrating a relation between a cache directory of FMPK and SGCB when SGCB is located in the package memory of FMPK in this embodiment;

FIG. 31 is a view illustrating a logical volume address-physical address conversion table in the embodiment; and

FIG. 32 is a view illustrating a relation among a logical volume address, a logical address, and a physical address in the embodiment.

### DETAILED DESCRIPTION

In the cache package, a cache package in which a flash memory package is installed is referred to as a flash memory package. In the flash memory package, a configuration in which a processor for processes such as logical address-physical address conversion is installed in the cache package in addition to a processor in the storage system is considered.

The processor in the storage system carries out a request for a cache control process to the processor in the flash memory package that is originally installed; the processor in the flash memory package carries out the cache control process triggered by the request; and the processor in the flash memory package responds process completion to the processor in the storage system after completion of the cache control process. As a result, a throughput can be improved because a controller processor can executes other processes instead of the cache control process.

In addition that a control is carried out so as to store the data segment of the target cache control in one flash memory package, the cache control process is processed by the processor in the flash memory package, and thereby, the throughput can further be improved because processes and communications with respect to the cache control process among the storage system and other flash memory package are reduced during processing the cache control process.

Both of users in an information provider side who wants to quickly provide up-to-date information to users in information receiver side who wants to acquire the up-to-date information can have advantage due to improvement of the throughput. For example, processes such as a database process of finance, medical service, and Internet service (SNS (Social Networking Service)) that requires real-time processing of read/write data in OLTP (OnLine Transaction Processing) is exemplified. When configuration scale of the storage system is required to be changed depending on change in business scale, the system can be introduced in a price that meets a capacity and performance by adding/removing several boards of flash memory packages based on a requirement.

The flash memory has a lower price per bit than a conventional DRAM (Dynamic Random Access Memory) or the like, and thus cache memories in which a large capacity of flash memory is installed at low cost can be used in the storage system. Increase in memory capacity is achieved by using the flash memory as the cache memory. Accompanying with this, however, throughput reduction caused by increase in the cache control process is concerned. Even in such a state, an effect of preventing reduction in the throughput can be exerted by the present invention.

Other contents of processes that the flash memory package including the flash memory and the processor for the flash memory package executes may include various functions such as a remote copy function. Also, the present invention is one of the inventions in which the load of the processor in the storage system is reduced and the throughput of the storage system is intended to improve by executing processes using the flash memory package. Hereinafter, embodiments of the present invention will be described with reference to the accompanying drawings. It should be noted that the embodiments are only examples for achieving the present invention and does not limit the technical range of the present invention.

### <Configuration of Storage System>

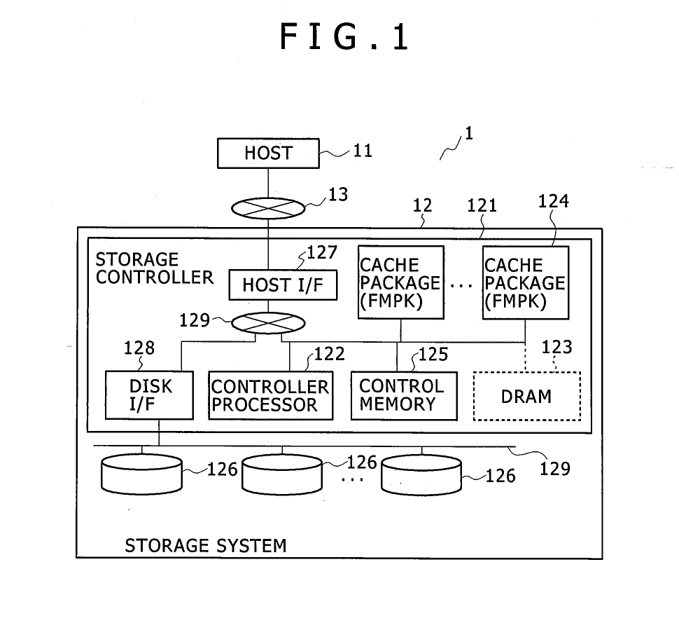

FIG. 1 is a block diagram illustrating a configuration of whole computer system in this embodiment.

This computer system 1 includes a host computer 11 and a storage system 12, and the storage system 12 is connected to the host computer 11 through, for example, a network 13. The host computer 11 is, for example, a mainframe, a server, or a client terminal. The network 13 is, for example, SAN (Storage Area Network) or LAN (Local Area Network). SAN is, for example, a network in which a fiber channel and protocols such as FCoE and iSCSI can be used and LAN is, for example, a TCP/IP network. The host computer 11 is directly connected to the storage system 12 not through SAN or LAN. The computer system 1 may have plural host computers 11 and storage systems 12. The host computers 11 and the storage systems 12 may be independently operated or may be redundant.

The storage system 12 includes a storage controller 121 and plural memory devices 126.

The storage controller 121 includes a controller processor 122, plural flash memory package (hereinafter referred to as FMPK) 124, and control memory 125, and further includes a host I/F 127 and a disk I/F 128. The storage controller 121 is connected to the host computer 11 through the host I/F 127. The storage controller 121 is also connected to the memory device 126 group through the disk I/F 128.

The controller processor 122 is, for example, CPU (Central Processor Unit). CPU executes a microprogram described below. CPU executes the process in the storage system 12 and, for example, executes a read-write process to the memory device.

In this embodiment, an example in which a cache package is configured by plural FMPKs 124 is described. A memory medium is not limited to FMPK but may be a semiconductor memory. In other words, for example, DRAM being a volatile memory and MRAM (Magnetic Random Access Memory), PRAM (Phase Change Random Access Memory), and ReRAM (Resistance Random Access Memory) being nonvolatile semiconductor memories may be used in addition to the flash memory. The cache memory temporarily stores write data received from the host computer 11 and read data read from the memory devices 126.

FMPK 124 has built-in nonvolatile flash memory chip (hereinafter also referred to as “FM”) that can retain data without power supply. DRAM 123 is, for example, a memory made of volatile DRAM that loses retained data if power is not supplied. In this embodiment, FMPK 124 is used as the cache package. FM has characteristics that updated data cannot be overwritten on a physical area where old data is stored when the data is rewritten and therefore, a package processor 501 in FMPK 124 does not overwrite the updated data on the physical area where the old data is stored but overwrites on a different physical area when the data is rewritten. A logical address associated with the physical area where the old date is stored is made to correspond to the physical area where the updated data is stored. In other words, the mapping of the logical address and the physical address is changed. Therefore, as long as a data deletion process is executed, even the updated old data is not overwritten and retained on the physical area of FM. FMPK 124, for which the control described above is required to be carried out, includes FM being a memory medium and the package processor 501 controlling FM.

The control memory 125 stores a microprogram 301, control information 302, and the like. Configuration element of the microprogram 301 will be described below. The control information 302 may be created with a start-up of the storage system 12 or may be dynamically created if necessary.

Examples of the memory device 126 include SSD (Solid State Drive), SAS (Serial Attached SCSI)-HDD (Hard Disk Drive), SATA (Serial Advanced Technology Attachment)-HDD, or the like. Here, the memory device 126 may be a device that stores data and is not limited to SSD and HDD. The memory device 126 is, for example, connected to the storage controller 121 through a communication path such as a fiber channel cable. Plural the memory devices 126 can configure one or plural RAID (Redundant Array of Independent Disks) group(s). Plural serial logical memory areas (this is referred to as a logical volume) can be configured on the memory device 126. The host computer 11 issues an access request in which the address space of the logical volume is assigned as an access location to the storage system 12 through the host I/F 127. The storage controller 121 controls an input-output process to the memory devices 126, that is, the read-write of data to the memory devices 126 in accordance with a command received from the host computer 11. The storage controller 121 can refer to or recognize a real memory area on the memory devices 126 by, for example, Logical Block Address (hereinafter referred to as LBW.

These DRAM 123, FMPK 124, controller processor 122, host I/F 127, disk I/F 128, memory device 126, and the like are connected each other through a bus or a network.

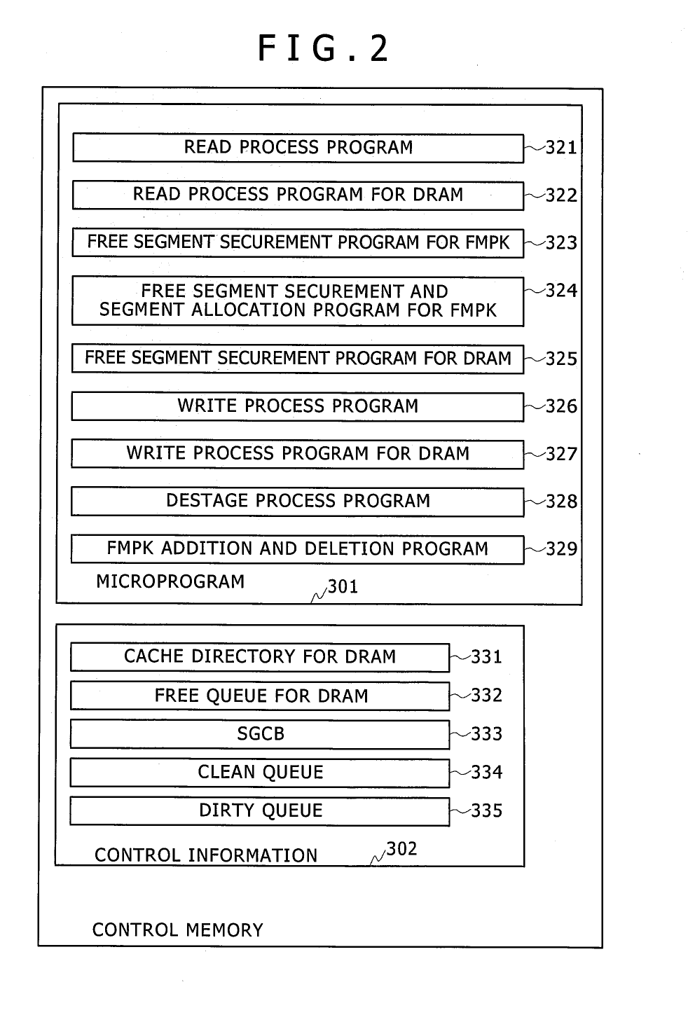

FIG. 2 is a view illustrating a configuration example of a microprogram 301 and control information 302 in the control memory 125.

The microprogram 301 includes a read process program 321, a read process program for DRAM 322, a free segment securement program for FMPK 323, a free segment securement and segment allocation program for FMPK 324, a free segment securement program for DRAM 325, a write process program 326, a write process program for DRAM 327, a destage process program 328, and FMPK addition and deletion process program 329, and controls operation of a hardware. The control information 302 includes a cache directory for DRAM 331, a free queue for DRAM 332, SGCB 333, a clean queue 334, and a dirty queue 335, and executes the microprogram 301 by using the information.

### <Configuration of FMPK>

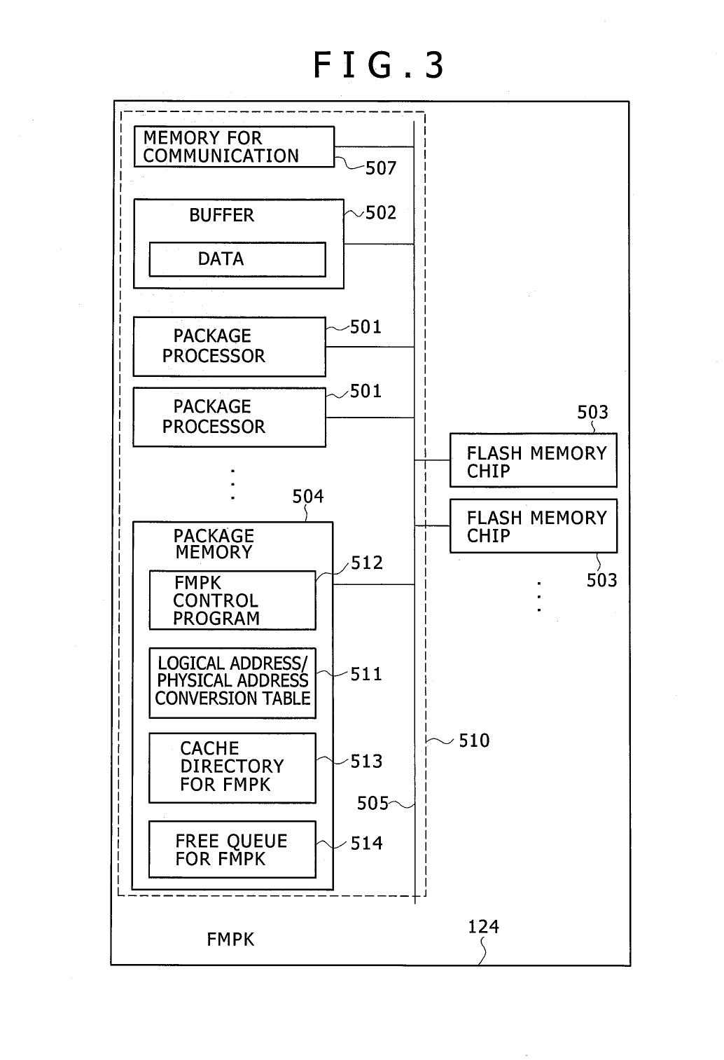

FIG. 3 illustrates a configuration example of FMPK 124 in this embodiment.

FMPK 124 has a memory controller 510 and plurality of flash memory chips 503 (for convenience, hereinafter described as FM or a flash memory). The memory controller 510 has the package processor 501, a buffer 502, a package memory 504, and a memory for communication 507. The package processor 501 receives data, communication messages, and the like and executes a process in accordance with the received request. The buffer 502 temporarily stores data transferred between the controller processor 122 and the flash memory chips 503. In this embodiment, the buffer 502 is a volatile memory. The memory controller 510 controls read-write of data to the flash memory chips 503.

The package processor 501 executes a FMPK control program 512 described below. The package processor 501 receives a request such as Hit/Miss determination from the controller processor and executes a process such as the Hit/Miss determination.

The package memory 504 stores the FMPK control program 512 that the package processor 501 executes and management information of the flash memory chip 503. The management information of the flash memory chip 503 includes, for example, a logical address-physical address conversion table 511, a cache directory for FMPK 513, and a free queue for FMPK 514. The management information of the flash memory chip 503 is important information, and thus, it is desirable that the management information can be saved in a specific flash memory chip 503 at the time of termination of the plan. It is also desirable that the system desirably has a battery in order to prepare for an unexpected failure and the management information can be saved to the specific flash chip 503 by using the battery even when the failure occurs.

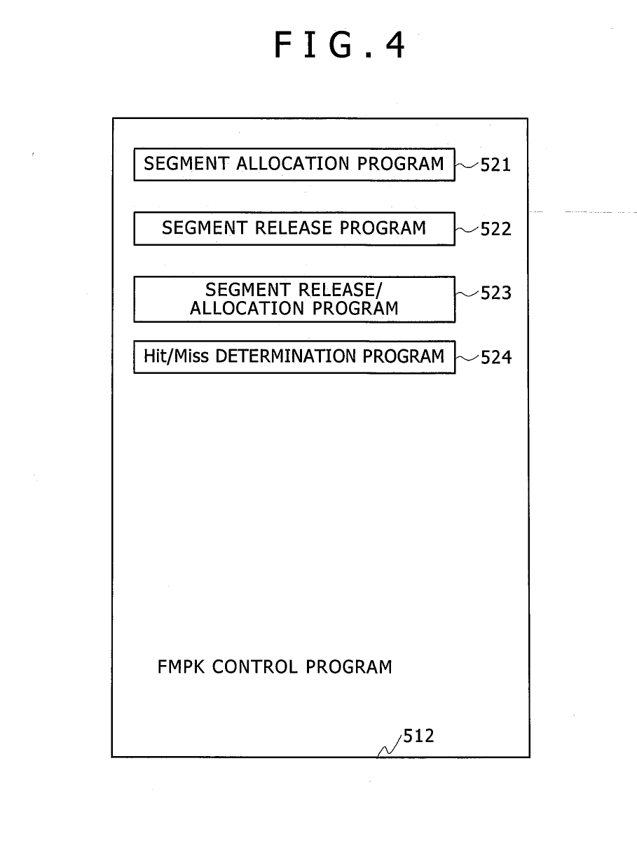

FIG. 4 is a configuration example of the FMPK control program 512 executed by the package processor 501 in FMPK.

The FMPK control program 512 includes a segment allocation program 512, a segment release program 522, a segment release/allocation program 523, and a Hit/Miss determination program 524. What operation is carried out by executing each program by the package processor 501 will be described below in detail.

### <Cache Directory and Segment Control Block (SGCB)>

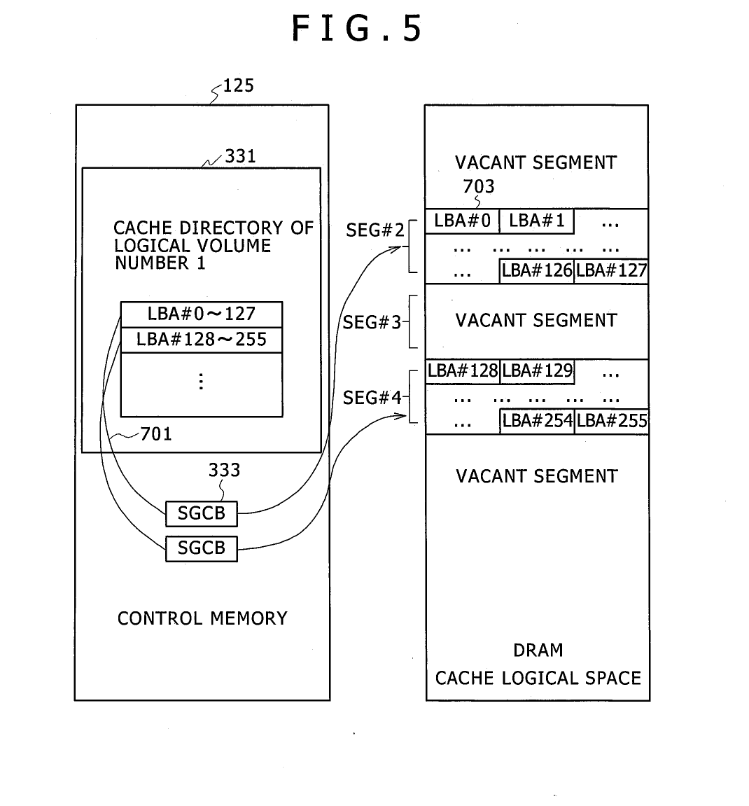

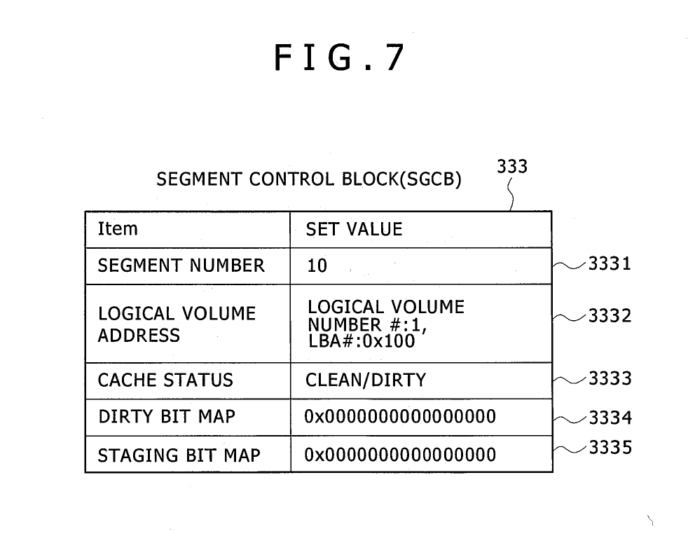

FIG. 5 and FIG. 7 are views illustrating the cache directory 331 and the segment control block (SGCB) 333 with respect to DRAM 123 in this embodiment.

The cache directory 331 illustrated in FIG. 5 has a pointer 701 to SGCB 333 in each certain area of a certain Logical Block Address Number (LBA#) in the logical volume. The case that the area of LBA# points SGCB 333 means that data is cached, while the case that the area of LBA# does not point SGCB 333 means that the data is not cached. A securement unit of the cache logical space is referred to as, for example, a segment and SGCB 333 is allocated to each segment. A size of one segment is 64 KB in this embodiment. On the other hand, a read-write access unit from the host computer 11 to the storage system 12 is referred to as a block, and LBA# is allocated in every 512 B in this embodiment. Therefore, one segment is formed by 128 of LBA# in this embodiment. The cache directory 331 exists in every volume in the storage system 12. When the host computer 11 issues a read or write access request to a logical volume, a memory area is assigned by assigning LBA#.

SGCB 333 illustrated in FIG. 7 stores information that indicates which LBA area in the cache logical space in which cache memory is pointed.

SGCB 333 is configured by a segment number field 3331, a logical volume address field 3332, a cache status field 3333, a dirty bit map filed 3334, and a staging bit map field 3335.

A segment number is a number for uniquely recognizing a logical area in DRAM 123 or FMPK 124 in the storage system 12. In each entry of the segment number field 3331, numbers corresponding to each segment in the cache logical space are stored. From the segment number, which logical area of DRAM 123 or FMPK 124 stores data can be determined.

The logical volume address is a number for uniquely recognizing a block in the logical volume, and indicates an address of stored location of a segment corresponding to a segment number stored in the segment number field 3331. In each entry of the logical volume address field 3332, a logical volume number indicating a stored location in the logical volume on DRAM 123 or FMPK 124 and a logical address (LBA#) corresponding to each block in the logical volume are stored.

A cache status indicates whether the logic space of DRAM 123 or FMPK 124 indicated by the segment number stores clean data or stores dirty data. In the cache status field 3333, information that indicates the data in the logical volume stored in the aforementioned segment is either a “clean” status or a “dirty” status on DRAM 123 or FMPK 124 is stored. The segment being in the clean status means that all blocks where data actually exists on the cache in the segment are clean. The block being in the clean status means that the data in the aforementioned block on the cache corresponds to data on the disk unit. The segment being the dirty status means that at least one block that is in a dirty status exists in the segment. The block being in the dirty status means that the data in the aforementioned block on the cache is not reflected on a click device yet.

The dirty bit map filed 3334 and the staging bit map field 3335 are fields indicating statuses of each block in the aforementioned segment. A bit length of each bit map is equal to the number of the blocks in the segment and each bit indicates each block. In each bit of the dirty bit map, 1 is stored when the corresponding block is in the dirty status, while 0 is stored when the corresponding block is in the clean status or the data does not exist. In each bit of the staging bit map, 1 is stored when the data in the corresponding block is in the clean status, while 0 is stored when the data is in the dirty status or does not exist. When the data in the aforementioned block does not exist on the cache, both bits corresponding to the aforementioned block are 0 in the dirty bit map and the staging bit map.

The purpose of the both bit maps is to determine whether the status on the cache memory in a unit of block in a segment is no data or the clean status or the dirty status. As long as the purpose is achieved, the meaning of both bits is not limited to the definition in this embodiment. For example, if it is decided that the system always refers to the dirty bit map in first in determination and whether the status is the dirty status or not is determined only by the dirty bit map (if the dirty bit is 1, then the staging bit is ignored), a status in which 1 is stored in the staging bit in the dirty status may be permitted.

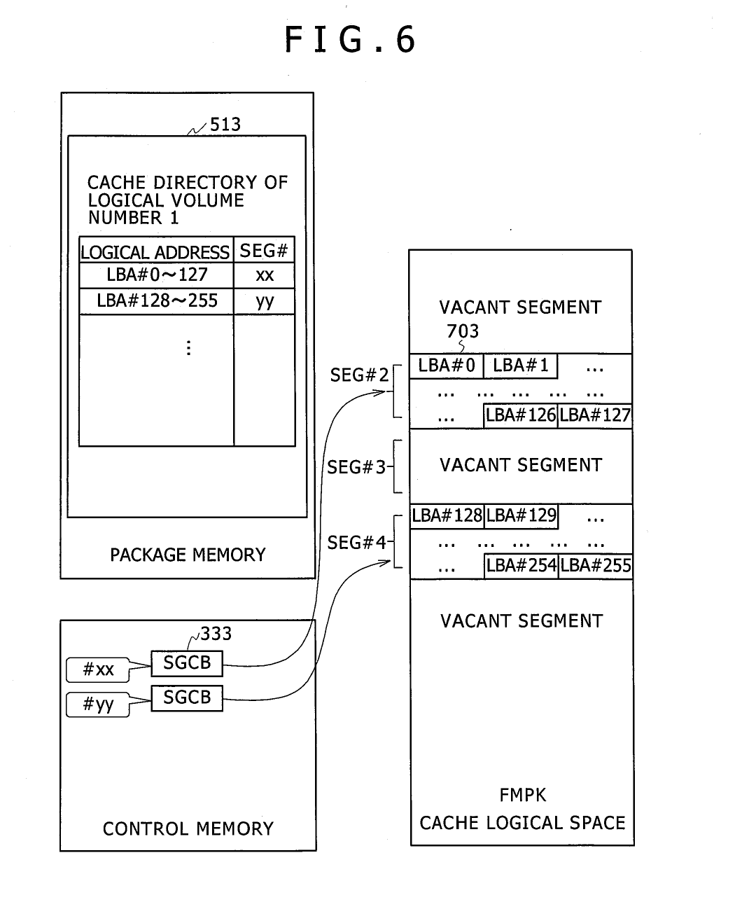

FIG. 6 and FIG. 7 are views illustrating the cache directory 513 with respect to FMPK 124 and SGCB 333.

The above-described configuration is similar configuration to the case that SGCB is made by DRAM (FIG. 5), and therefore, different parts will be described. In the case of FMPK 124, the cache directory 513 is not provided in the control memory 125 but the cache directory for FMPK 513 is provided in the package memory in FMPK 124. In this embodiment, a segment number stored in the segment number field 3331 to each certain LBA# in the logical volume is allocated instead of the pointer that directly indicates SGCB because SGCB is located on the control memory 125. The case that a segment is pointed to SGCB 333 corresponding to the allocated segment number indicates that data is cached, while the case that a segment is not pointed indicates that the data is not cached.

### <Relation Between Logical Space and Physical Space of FM>

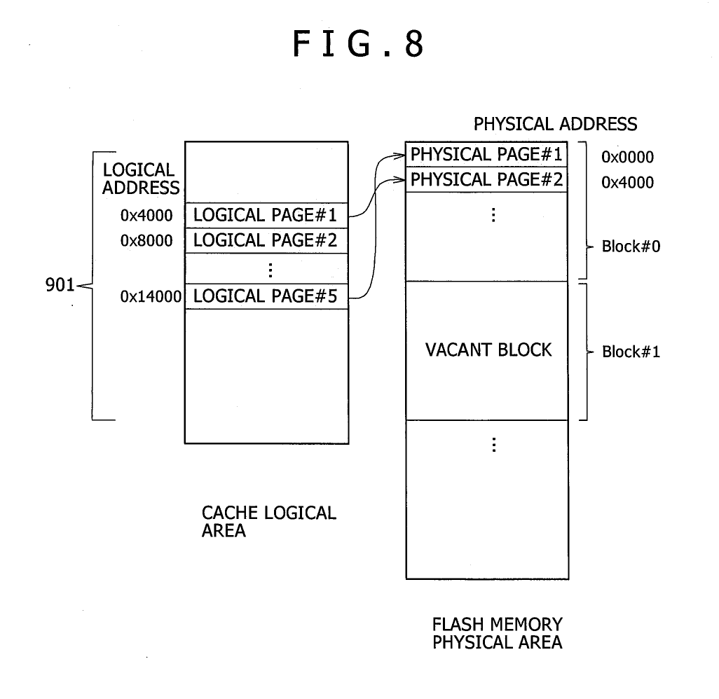

FIG. 8 is a view is schematically illustrating the relation between the logical space and the physical space of FMPK 124 in this embodiment.

The flash memory is a recordable memory. Consequently, when FMPK 124 receives updated data, the updated data is not written on a physical area where old data is stored but written on another physical area due to characteristics of the memory. Therefore, FMPK 124 manages a logical area corresponding to a physical area. Also, FMPK 124 divides the physical space into plural blocks, divides the block into plural pages, and allocates the physical area to a logical area in a page unit. FMPK 124 partitions the logical area into every predetermined size and manages each partitioned logical area as a logical page. FMPK 124 stores the logical address-physical address conversion table 511 that manages a corresponding relation between the logical page and the physical page in the physical area allocated to the aforementioned logical page in the package memory 504. The block described here is different from the block that is uniquely distinguished by LBA# and has a size of 512 B described above, and is a block uniquely distinguished only in FMPK 124 and having a size of, for example, 2 MB. A size of the page is, for example, 8 KB or 16 KB. In the flash memory, deletion is carried out in a block unit and read-write is carried out in a page unit due to characteristics of the memory.

In the following embodiment, a physical page that is allocated to a logical page may be referred to as an effective physical page; a physical page that is not allocated to any logical pages may be referred to as an ineffective physical page; and a physical page in which data is not stored may be referred to as a vacant physical page. For example, when updated data is received, a physical area in which the old data is stored is referred to as the ineffective physical page, and a physical area in which the new data is stored is referred to as the effective physical page. Allocation of a physical page to a logical page may result in a target of a read request or a write request to the data stored in the physical page. Consequently, the data stored in the effective physical page is not a target of deletion. On the other hand, no allocation of a physical page to any logical pages means no read and no write of the data stored in the physical page. As a result, this means that the data stored in the ineffective physical page can be deleted.

As described above, when the block has no vacant physical pages, FMPK 124 allocates a vacant physical page from another block. In this manner, a vacant volume in FMPK 124 is decreased when vacant physical pages are used in order to store data. FMPK 124 executes a reclamation process described below when the number of vacant blocks in FMPK 124 becomes fewer. Generally, at the time of executing the reclamation process, the data in the physical page becomes a target for deletion, after allocation from the logical page (the page in 901) used for data storage to a logical volume that stores write data to the physical page becomes none.

A deletion unit in FMPK 124 is the block unit in FIG. 8. Consequently, when a physical page storing data that is not a target for deletion (an effective physical page) and a physical page storing data that is a target for deletion (an ineffective physical page) coexist in a certain block, the block is deleted after the data stored in the effective physical page is copied to a vacant page in another block. By this operation, vacant blocks can be created and vacant volume can be increased. This process is referred to as the reclamation process.

### <Logical Address-Physical Address Conversion Table in FMPK>

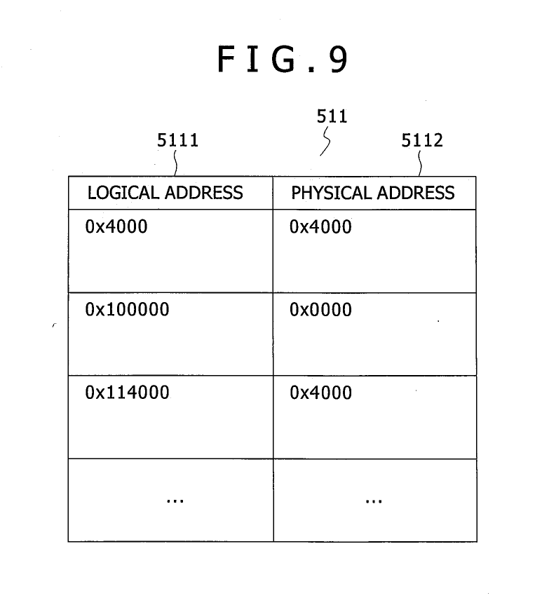

FIG. 9 is a view illustrating a logical address-physical address conversion table 511 in this embodiment.

The logical address-physical address conversion table 511 includes a logical address field 5111 and a physical address field 5512. The logical address field 5111 includes a logical address indicating a cache area for the data stored in the logical volume. When updated data is stored in a vacant physical page, a corresponding relation between the logical address and the physical address in this table is updated. This is a relation between the logical space and the physical space when the cache is configured by FMPK 124. When the cache is configured by DRAM, the logical space is equal to the physical space and plural logical pages are not allocated to one physical page.

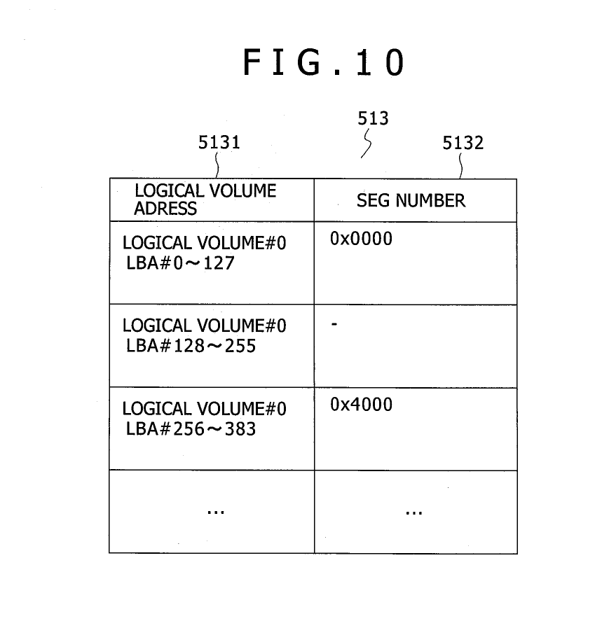

FIG. 10 is a view illustrating the cache directory for FMPK 513 in this embodiment.

The cache directory for FMPK 513 is configured by an entry having a logical volume address field 5131 and a segment number field 5132. To an area of the logical volume address stored in the logical volume address field 5131, which segment in the aforementioned FMPK is allocated to each entry is indicated by the segment number stored in the segment number field. When the segment is not allocated, the segment number field is indicated as blank. In other words, data in the LBA# area written in the logical volume address field is stored in a segment having a corresponding SEG number. When Hit/Miss determination described below is requested from the controller processor 123, the package processor specifies the SEG number based on the logical volume address information (a logical volume number and a logical address (LBA#)) and the cache directory for FMPK 513 and determines whether the data is stored or not based on the specified SEG number from the FMPK cache logical space illustrated in FIG. 6. At this time, the package processor can specifies the physical area of FM by using the logical address-physical address conversion table 511 illustrated in FIG. 9.

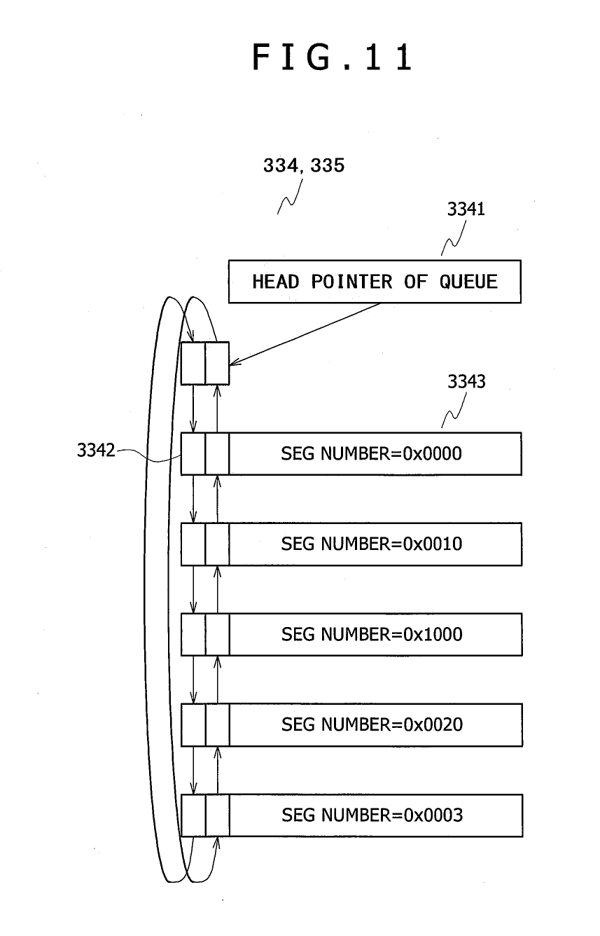

FIG. 11 is a view illustrating an example of a clean queue 334 and a dirty queue 335 in this embodiment.

The clean queue 334 is a queue, which is located in the control memory 125, for controlling a release order of the segment in a clean status that is already allocated. The clean queue is made of plural queues and a queue entry is made of a segment number field 3343 that indicates SGCB and a pointer 3342 that indicates the previous and next queue entries. The queue entry indicating a recently accessed (MRU: Most Recently Used) segment is connected to the head of the queue and an entry indicating finally accessed (LRU: Last Recently Used) segment is connected to a tail end of the queue. A free segment securement program described below can increase a hit ratio in a manner that the data having high re-reference possibility in the access from the host preferentially remains in the cache memory by selecting a release target memory in the chronological order from the clean queues.

The dirty queue 335 has a similar queue structure to the clean queue and has a difference in that a segment in a dirty status is connected. A destage process program described below can effectively carry out a destage process in a manner that destage is delayed for the data frequently accessed to the same segment and the destage is carried out from the data not so frequently accessed in turn in the access from the host by selecting the target segment for the destage in the chronological order of these dirty queues. In this embodiment, the segment number is stored in the queue entry of the clean queue and the dirty queue. However, the queue entry may also directly points SGCB.

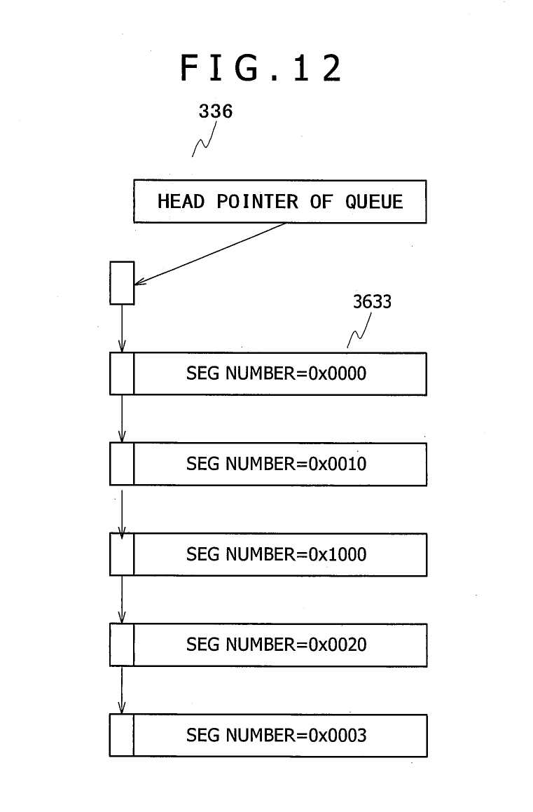

FIG. 12 is a view illustrating an example of a free queue for DRAM 123 and a free queue 336 for FMPK 124 in this embodiment.

The free queue for DRAM 123 is located in the control memory 125 and is a queue that manages free segments in DRAM 123, while the free queue for FMPK is located in the package memory 504 and is a queue that manages free segments in FMPK. Each entry of the free queue is made of a segment number field 3633 for recognizing a free (unallocated status) segment and a pointer indicating the next entry.

### <Method for Requesting Process to FMPK>

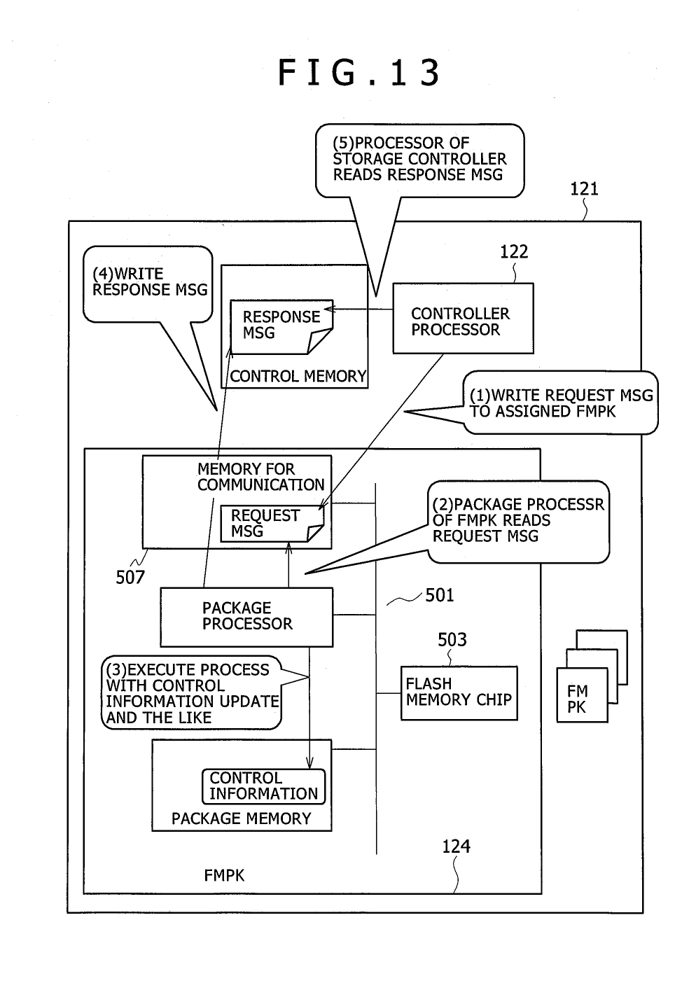

FIG. 13 is an explanatory view of communication method when the controller processor 122 requests a process to FMPK 124. By this process, the package processor can executes the process that has been executed by the controller processor.

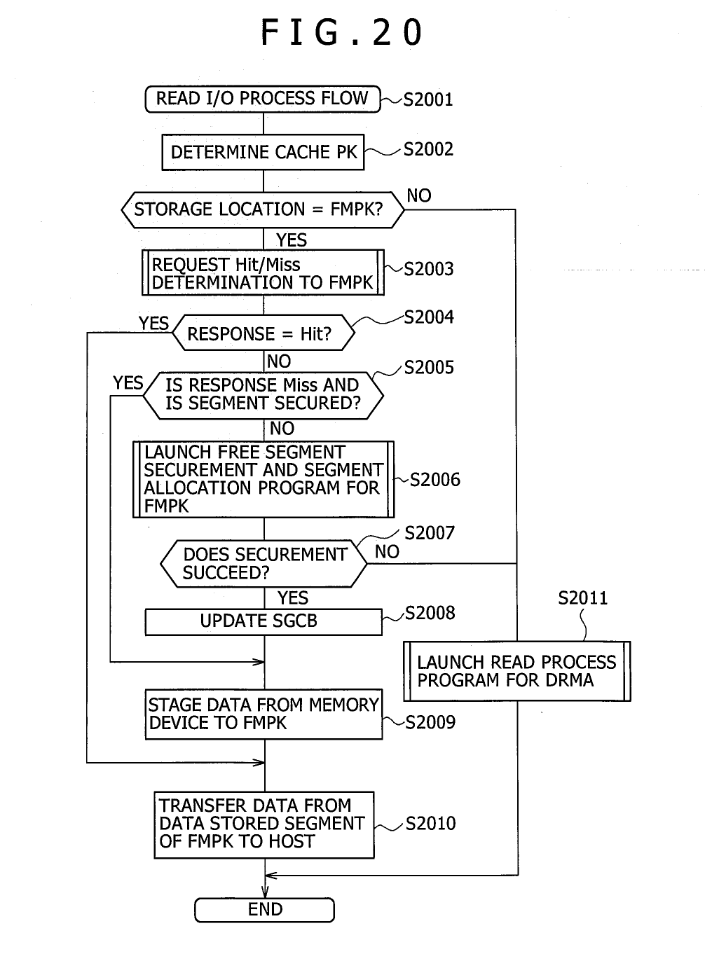

The controller processor may request execution of a specific process to FMPK 124 during executing the process of the microprogram illustrated in FIG. 20 and the subsequent figures. At this time, the controller processor communicates to FMPK 124 using this method. First, the controller processor writes a request message in a memory for communication in FMPK 124 (1). The request message includes information indicating the requested process (Hit/Miss determination, release of segments, and the like) and its parameter (a logical volume address of the target of the Hit/Miss determination, and the like). Subsequently, the package processor in FMPK 124 reads the request message from the memory for communication (2). The package processor periodically reads the memory for communication (polling) to check whether the request message is arrived or not. Subsequently, the package processor 501 in FMPK 124 executes the program based on the information indicating the request process included in the request message (3). Examples of the executed program includes a program including control information update and a data transfer program (a program in which an assigned data is transferred from the flash memory chips 503 to the host computer 11 through the host I/F 127) illustrated in FIG. 20 and the subsequent figures. After completion of these programs, the package processor 501 in FMPK 124 writes a completion message to the control memory 125 in the storage controller (4). The completion message includes processed results such as information of whether the process succeeds or fails and segment numbers. Finally, the controller processor 122 reads the completion message from the control memory 125 (5). The controller processor 122 can move to another process after receiving the request message in (1), and periodically polls arrival of the completion message on the control memory 125. After reading the completion message, a subsequent process is executed based on the processed result included in this message.

What process is requested by what trigger to FMPK 124 in the specific program executed in the controller processor 122 and how the subsequent process is executed based on the result is illustrated in FIG. 20 and the subsequent figures.

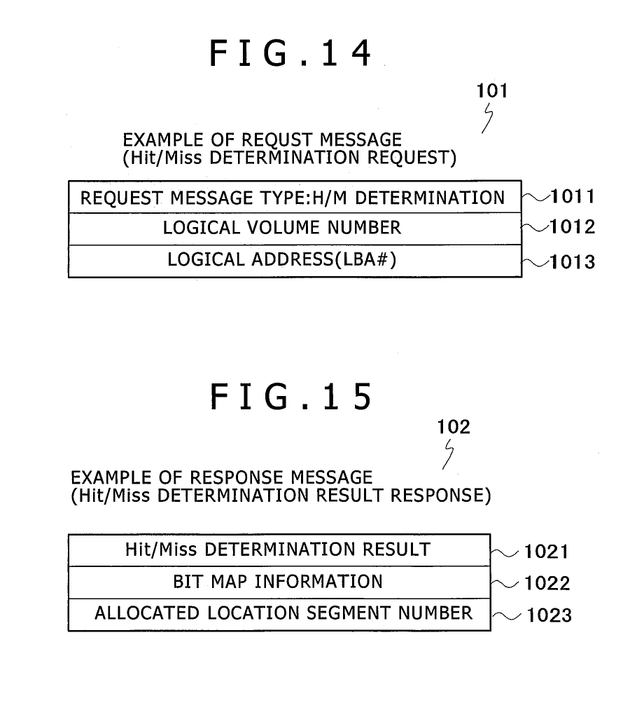

Each of FIG. 14 and FIG. 15 is examples of a request message and a response message, respectively.

FIG. 14 is an example of a Hit/Miss determination request massage 101 and the Hit/Miss determination request massage includes three fields of a request message type, a logical volume number, and a logical address (LBA#). In the request message type field 1011, an identifier (for example, a string indicating a request content or an identification number) indicating requested process contents. Information required for executing the requested process is stored in another field. The required information is different each other depending on the request contents, and thus, a field configuration is different in accordance with the required information. For example, in the Hit/Miss determination process in this example, the logical volume number and the logical address (LBA#) are stored in the logical volume number field 1012 and the logical address field 1013, respectively.

FIG. 15 is an example of the response message 102 to the Hit/Miss determination request message and the response message is made of a Hit/Miss result field 1021, a bit map field 1022, and an allocated location segment number field 1023. These field configurations are different depending on types of the response messages. In the case of the Hit/Miss determination, a Hit/Miss determination result (Is the result Hit or Miss? Is the segment allocated or not, when the result is Miss?) is stored in the Hit/Miss result field 1021 and, for example, a bit map representing whether the data exists or not in a block unit in the aforementioned segment is stored in the subsequent bit map field 1022. The bit map is a bit map that is used for determining whether an access target area in the segment exists in the cache memory or not, and other form (for example, a block number) can be employed. The allocated location segment number field 1023 stores a number that is allocated to the aforementioned logical volume address or that identifies the segment in the flash memory package being newly allocated. The controller processor can determine the address of the allocated location segment (that is, the address used when data is transferred between the controller processor and the flash memory package) based on this number. Alternatively, not the number but the address can be returned.

### <Determination and Change of Access Location FMPK>

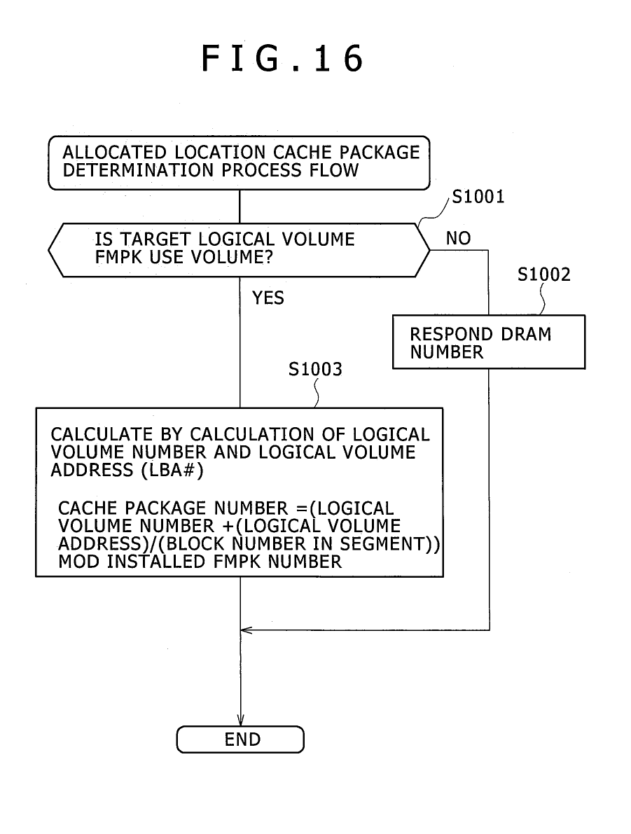

FIG. 16 is a flowchart of an allocated location cache package determination process program.

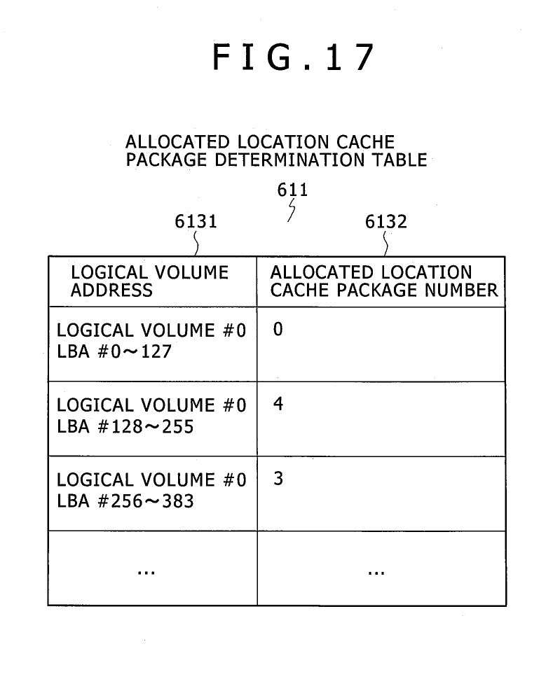

This program is executed by the controller processor 122 when this program is called by the read process program or the write process program. This program is called with the logical volume number and the logical address (LBA#). First, this program determines whether the logical volume indicated by the logical volume number is a logical volume that stores data using FMPK 124 or not (S1001). Whether the logical volume indicated by the logical volume number is a logical volume that stores data using FMPK 124 or not may be set by a user or may be determined by an access pattern to the aforementioned logical volume in the host (a volume that reads a specific LBA# many times is willingly allocated because the volume has a good relation with FMPK 124). As another method, there is a method in which the allocated location is not determined by calculation but determined in accordance with a predetermined table. For example, the allocated location FMPK 124 can also be determined from the logical volume number and the logical address by storing an allocated location cache package determination table 611 illustrated in FIG. 17 in the control memory 125 and referring to this table. Subsequently, if the volume is not a used volume, then the program responds that DRAM 123 is used (S1002). If the volume is a volume that uses FMPK 124, then the program proceeds to the step S1002 and determines the number of allocated location FMPK 124 by calculation. A method for determining the number is, for example, a method in which a logical address (LBA#) is divided by a block number in a segment (The number of blocks that configure one segment, and determined by (Segment size)/(Block size)), and, after a logical volume number is added to the divided number, a remainder that is generated by dividing the resultant value by the total number of FMPK 124 is determined (“mod” represent an calculation to obtain a remainder generated by division). By this operation, the allocated location FMPK 124 can be distributed in a segment unit, and the load off-loaded to FMPK 124 can be distributed in a balanced manner. An allocation unit to FMPK 124 may be adjusted to a segment that is an allocation unit in the cache area.

FIG. 17 is a view illustrating an example of the allocated location cache package determination table 611.

This table is used when the controller processor interprets access from the host computer 11, determines the target logical volume number and logical address (LBA#), and determines the storage location cache package of the access target data, and the table is stored in the control memory 125. This table is made of plural entries including a logical volume address field 6131 and the allocated location cache package number field 6132. At the time of storing data, the data stored in an address area of the logical volume listed in the logical volume address field is stored in the cache package allocated in this address area. By updating this table, an allocation of the cache package can be changed. Particularly, many cache control processes can be off-loaded to the aforementioned package by allocating many address areas. In order to achieve a load balance between the cache packages, the controller processor can control so that the load is reduced by narrowing the area of LBA# allocated to the cache package having high load, or, on the contrary, can control so that the load is increased by widening the logical volume address area allocated to the cache package having low load.

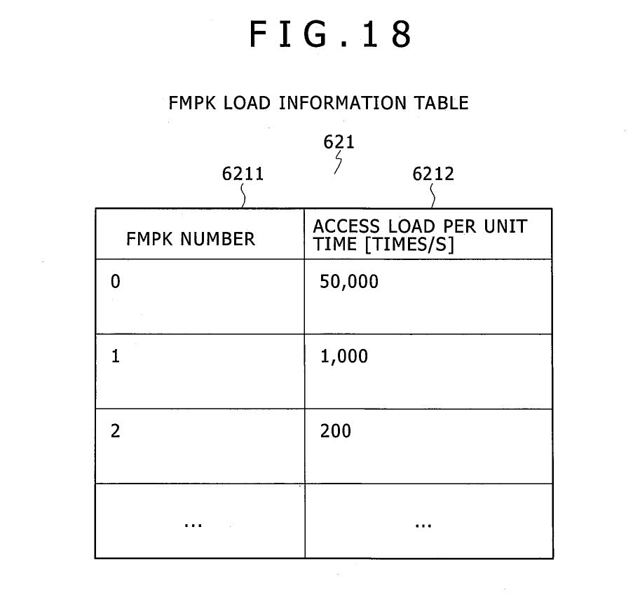

FIG. 18 is an example of a FMPK load information table 621.

The FMPK load information table 621 is stored in the control memory in the storage controller, and each piece of FMPK load information is stored in each entry. FIG. 18 illustrates an example of recorded access load in a unit time as the load information.

The controller processor may measure loads of each FMPK and may stores in the control memory. Alternatively, the controller processor may control so that the package processor of FMPK measures loads and the load information is stored in the control memory, if necessary (for example, at the time of changing the allocated location FMPK, or at regular time intervals). Examples of the load include the number of command issues with reference to Hit/Miss determination to FMPK per unit time and the total number of passed writes to FM. FM used as a memory medium, which is a medium that deteriorates in every data erasing, more deteriorates because the number of erasing is increased when the number of writes is high. In addition, write of data to FMPK is generated by using FM as the cache memory because staging of data of the access location from the memory device is carried out when Miss occurs even at the time of read (data writing to FMPK occurs at the time of write-Hit or write-Miss). In consideration of not only the number of accesses and the number of writes per unit time but also a degree of deterioration of FM, a lifetime of FMPK can be extended in a manner that the load to FMPK is measured by distinguishing at the time of read-Hit and at the time of read-Miss/write-Hit/write-Miss; the logical volume address is changed based on the measured value; and control allocating an address area is carried out.

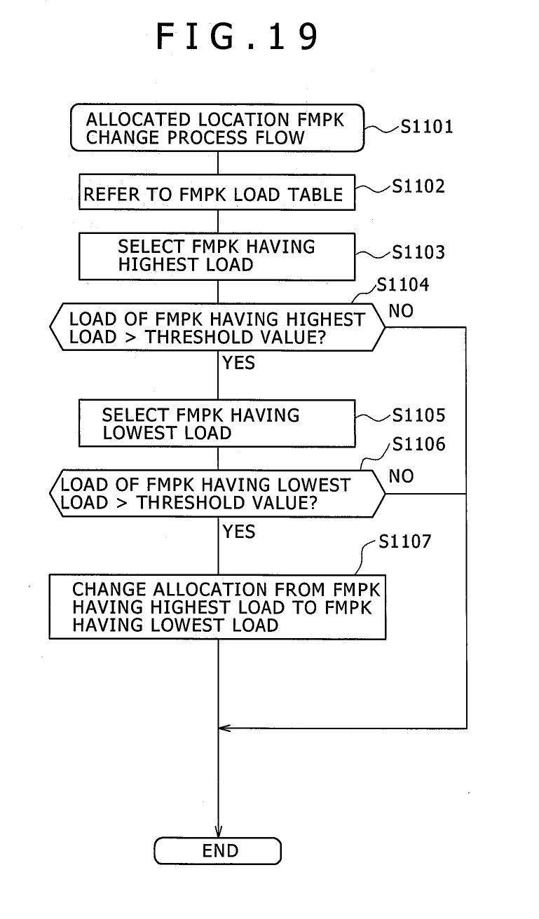

FIG. 19 is a flowchart of an allocated location FMPK change process program. This program is executed by the controller processor. For example, the program is executed when a total amount of access to FMPK, the number of access times per unit time, or the total number of writes exceed threshold values or at regular time intervals.

First, the program refers to the FMPK load information table 621 in FIG. 18 (S1102). The program acquires load information of each FMPK and selects FMPK having the largest load (S1103). Subsequently, the program determines whether the load of FMPK having the largest load exceeds the threshold value or not (S1104). When the load does not exceed the threshold value, the program is terminated. Subsequently, the program selects FMPK having the lowest load (S1105). The program determines whether the load of FMPK having the lowest load underruns the threshold value or not (S1106). When the load does not underrun the threshold value, the program is terminated. If both conditions are Yes, allocation of the logical volume address area having a predetermined amount is changed from FMPK having the highest load to FMPK having the lowest load (S1107). Thereafter, the program updates the allocated location cache package determination table 611.

### <Read-Write Process>

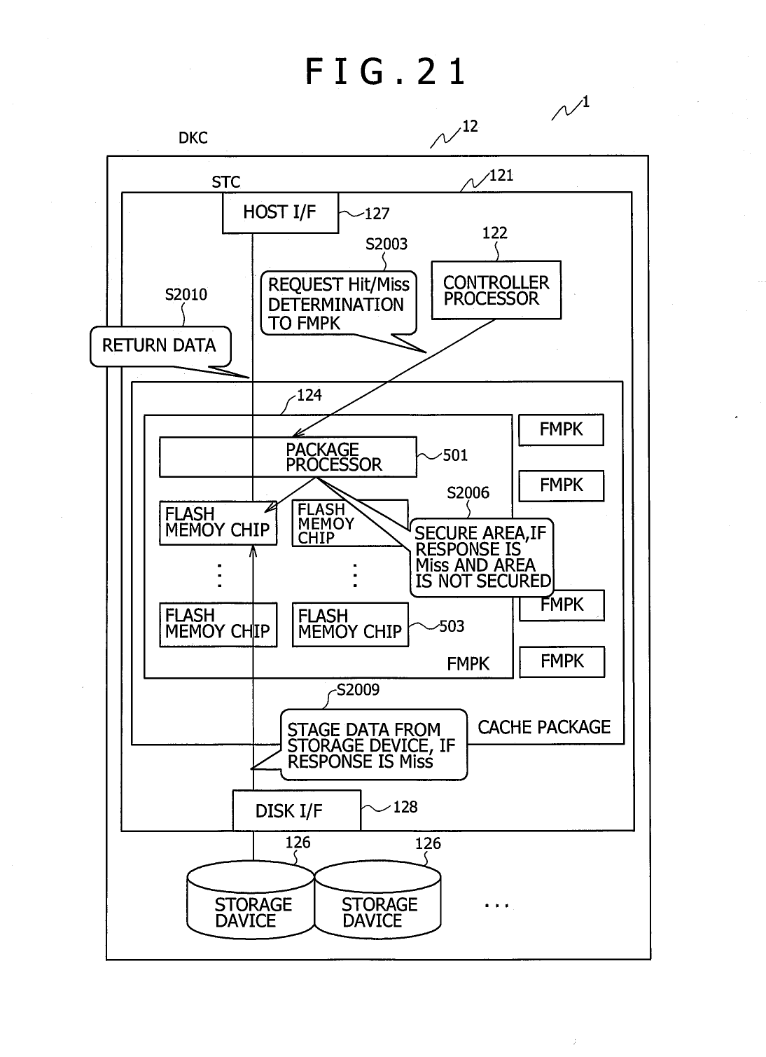

FIG. 20 is a flowchart of the read process program. FIG. 21 is a schematic diagram corresponding to a read I/O process program illustrated in FIG. 20.

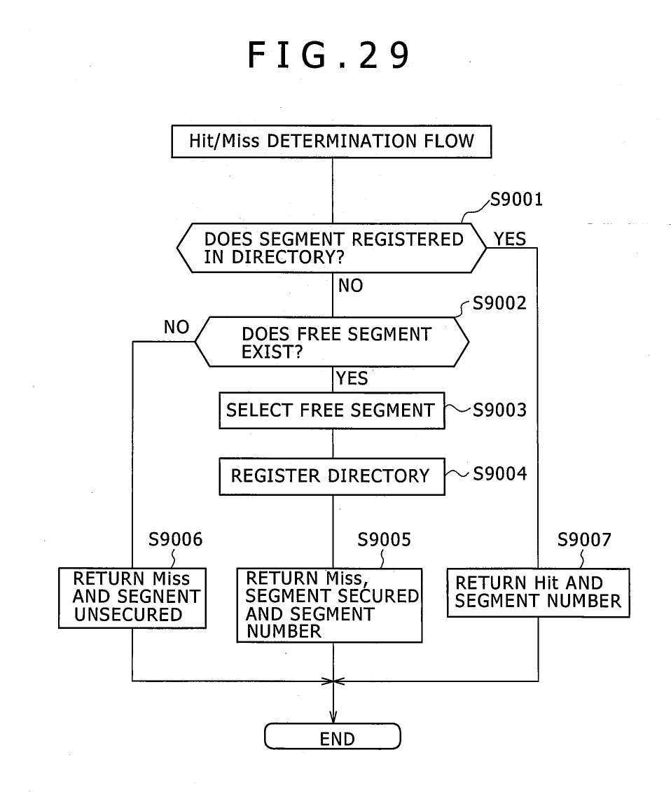

This program is executed by the controller processor 122 when a read command is received from the host computer 11. The program interprets the access request from the host, determines the target logical volume number and logical address (LBA#), and determines the storage location cache package of read target data (S2001). This determination may be determined based on the allocated location cache package determination process program or may be determined by referring to an allocated location cache package table illustrated in FIG. 17. After the storage location cache package of the read target data is determined, the program determines whether the aforementioned cache package type is FMPK 124 or not (S2002). When the cache package type is not FMPK 124 (when the cache package type is DRAM 123), a read process program for DRAM described below is executed (S2011). When the aforementioned cache package is FMPK 124, the program requests the Hit/Miss determination to FMPK 124 (S2003). A request method is a communication method as illustrated in FIG. 13. The package processor in FMPK 124 executes the Hit/Miss determination process illustrated in FIG. 29 by responding this request, and a completion message of this process is stored in the control memory. When the completion message arrives, the controller processor 122 reads this message and determines whether the result is Hit or not (S2004). When the result is Hit, the controller processor instructs FMPK to transmit data to the host I/F, and the package processor 501 in FMPK 124 that receives the instruction transmits the data from the data storage segment to the host I/F 127. The host I/F 127 returns the data to the host computer 11 (S2010). When the result is not Hit, the controller processor 122 determines whether the segment is already secured or not by the response message (S2005). When the segment is already secured, the controller processor 122 reads the data in the target logical volume from the memory device 126 and stages the data to the allocated location segment included in the response message responded from FMPK 124 (storing the data read from the memory device 126) (S2009). When the segment is not secured yet, the controller processor 122 launches a free segment securement and segment allocation program for FMPK 124 (S2006) and requests the process to the package processor in FMPK (described below in detail). The package processor 501 determines whether an allocation of the segment is successful or not (S2007). If the allocation fails, the package processor 501 does not store the data to FMPK 124 and the controller processor 122 selects DRAM 123 as a storage location again and launches the read process program for DRAM (S2011). When the segment allocation succeeds, the package processor updates SGCB such as writing the logical volume number and the logical address to SGCB which indicates the allocated segment on the control memory 125 to clean the status and setting a staging bit at a data storage position in the segment (S2008). Thereafter, the program proceeds to step S2009.

The controller processor 122 can executes other processes during from requesting the Hit/Miss determination to waiting the completion message of the Hit/Miss determination. This can increase an operation rate of the processor, and thus, has an effect for improvement of the storage system throughput (improvement of performance).

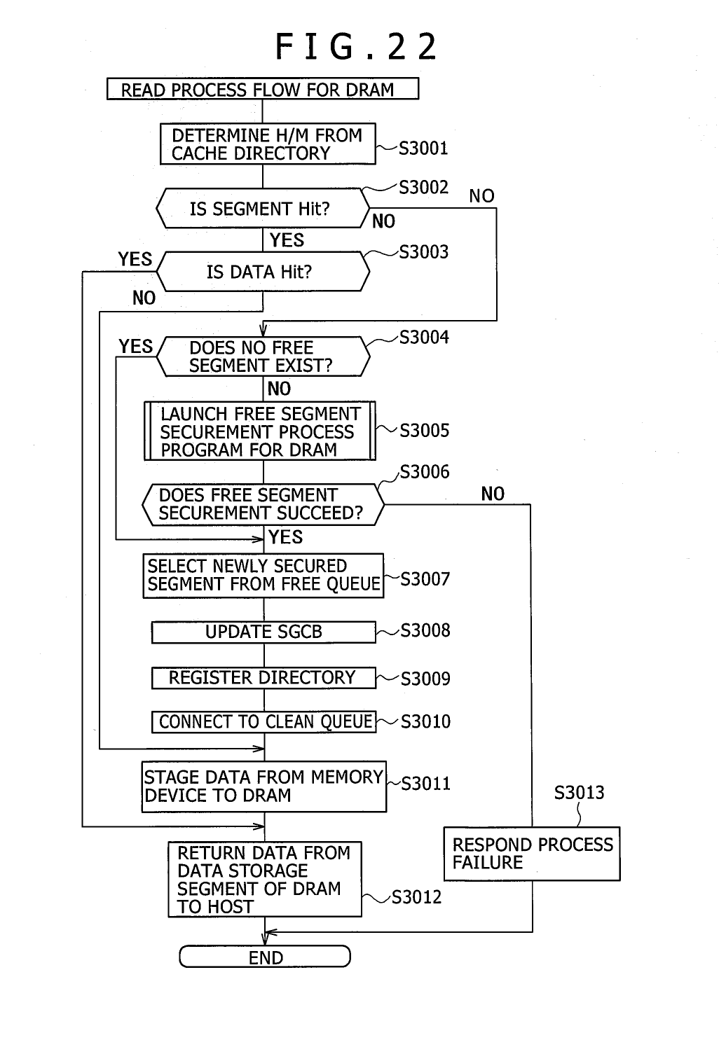

FIG. 22 is a flowchart of a read process program for DRAM.

This program is executed by the controller processor 122 when a read command from the host computer 11 is received. First, the program refers to a cache directory of the control memory 125 to execute the Hit/Miss determination of DRAM 123. Specifically, the program determines whether a pointer corresponding to the target logical volume address of the logical volume in the cache directory that is an access target points SGCB allocating the aforementioned logical volume area or not (S3001). When the segment is already allocated (Hit) as the determination result (when the result is Yes in S3002), the program determines whether the access target data in the segment is Hit or not (S3003). Specifically, this is determined by a status of a bit of a staging bit map in SGCB. When the determination result is Hit for the data, the program sends the data from DRAM 123 to the host I/F 127, and the host I/F 127 returns the data to the host computer 11 (S3012). When the result is Miss for the data, the controller processor stages the data from the memory devices 126 to the aforementioned segment of DRAM 123 (S3011). When the segment is not allocated (Miss) as the result of determination (when the result is No in S3002), the program subsequently determines whether a free segment exists or not in the aforementioned DRAM 123 (S3004). Specifically, this is determined by referring to a free queue. When the free queue does not exist, a free segment securement process program for DRAM is launched (S3005). The free segment securement process program for DRAM determines whether the free segment can be secured or not (S3006). When the free segment is not secured, this failure is reported to the host computer 11 (S3013). When the free segment is secured, the program selects a newly secured segment from the free queue (S3007), updates SGCB indicating the aforementioned segment (S3008), registers to the directory (S3009), and connects SGCB to a clean queue (S3010). Then, the program proceeds to a step S3011.

In the Hit/Miss determination illustrated in FIG. 20, FIG. 21, and FIG. 22, it is premised that a specific FMPK 124 is allocated to a specific logical volume address. As another method, there is a method that determines which FMPK 124 is allocated.

For example, the following method is considered. First, the Hit/Miss determination is requested to any FMPK 124. When the result is Miss, the Hit/Miss determination is requested to another FMPK 124 and this operation is repeated to determine whether which FMPK 124 and which part of the FMPK 124 is Hit or all FMPKs 124 are Miss. Alternatively, the Hit/Miss determination may be simultaneously requested to all FMPKs 124. By this operation, all FMPKs 124 can be allocated to all logical volume address spaces, and therefore, a storage capacity in FMPK can be effectively used. As another method, a method in which cache directory information of all FMPKs 124 is copied to each FMPK 124 and, by requesting the Hit/Miss determination to any one of FMPKs 124, the requested FMPK can determine Hit/Miss determination to other FMPKs 124 can be considered. In this method, synchronous between FMPKs 124 in the cache directory information is required. In this method, however, the controller processor 122 is not required to execute the allocated location cache package determination process as illustrated in FIG. 15 and to have the allocated location cache package determination table illustrated in FIG. 16.

The synchronous in the cache directory information will be described. Namely, the synchronous means that when the package processor allocates a segment to a logical volume address in a certain FMPK (referred to as allocated FMPK), the cache directory information on the other FMPKs is simultaneously updated. Specifically, the package processor of FMPK that executes allocation communicates to the other FMPKs before updating the cache directory information and informs that the package processor confirms that the aforementioned logical volume address is unallocated and allocates to the aforementioned logical volume address. The package processor in the other FMPKs that receive the communication only tentatively registers the aforementioned logical volume address to the cache directory if not allocated and informs the allocated FMPK of unallocation of the aforementioned logical volume address. When the aforementioned logical volume address receives the Hit/Miss determination request from the controller processor, FMPK in the status that is tentatively registered to the directory is in a status of waiting directory update notice from the allocated FMPK, suspends response to the controller processor, and does not determine the Hit/Miss determination for the aforementioned logical volume address until a later cache directory update notice or a tentative registration deletion notice is received from the allocated FMPK. When the allocated FMPK receives response of unallocation from all of other FMPKs, the allocated FMPK allocates segments, updates the cache directory information, and informs the other FMPKs of update of the cache directory information. The other FMPKs receive the notice and update the cache directory of the noticed FMPK. When suspending the response to the controller processor, the other FMPKs continue to carry out the process.

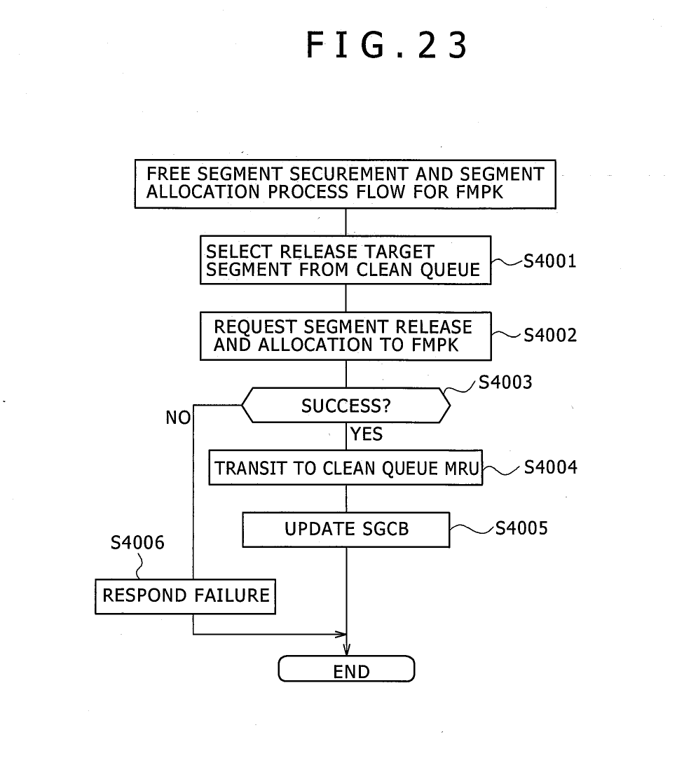

FIG. 23 is a flowchart of a free segment securement and segment allocation process program for FMPK that secures and allocates a physical area in an unallocated status of FMPK and corresponds to S2006 in FIG. 20. This program, which the package processor executes responding to a request of the controller processor, has an effect of reduction in time for cache control executed by the controller processor.

This program is launched by the controller processor 122 and executed by the package processor 122 of FMPK 124 responding to the request from the controller processor 122 to FMPK 124. First, the controller processor 122 refers to a clean queue corresponding to the aforementioned FMPK 124 of the control memory 125 and selects a release target segment (S4001). The release target segment is desirably the oldest segment in the clean queue. The controller processor 122, however, detects a status in which, for example, an access that targets data of an area including the aforementioned segment is processing, and another segment may be determined as a release target (for example, a segment connected next to the oldest segment in the queue). Subsequently, the controller processor assigns the release target segment to the package processor of FMPK 124, and assigns LBA# to request release and allocation of the segment to the package processor (S4002). Then, the controller processor determines an allocated result (S4003), transits the aforementioned SGCB to MRU in the clean queue if the result is successful (S4004), and updates a content of SGCB in accordance with the newly allocated target area (S4005). If the allocation fails, then the controller processor responds the failure and terminates the program (S4006).

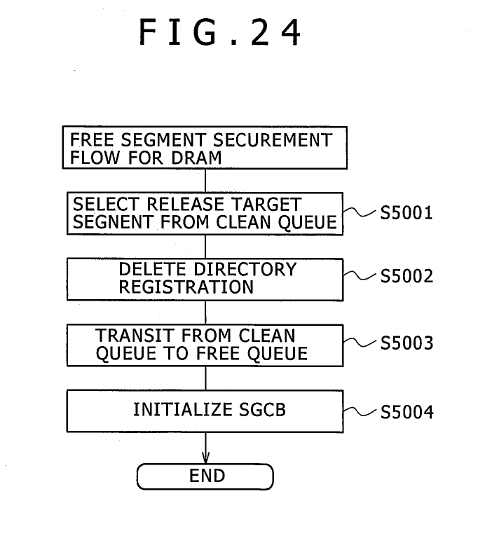

FIG. 24 is a flowchart of a free segment securement process program for DRAM that secures a physical area of an unallocated status in DRAM and corresponds to S3005 in FIG. 22.

This program is launched by the controller processor 122 and executed by the controller processor 122. The program selects the release segment that is finally accessed by the clean queue on the control memory (S5001), deletes the target segment from the directory (S5002), transits from the clean queue to a free queue (in other words, the program release the connection to the clean queue and reconnects to the free queue) (S5003), and finally initializes a content of SGCB (S5004).

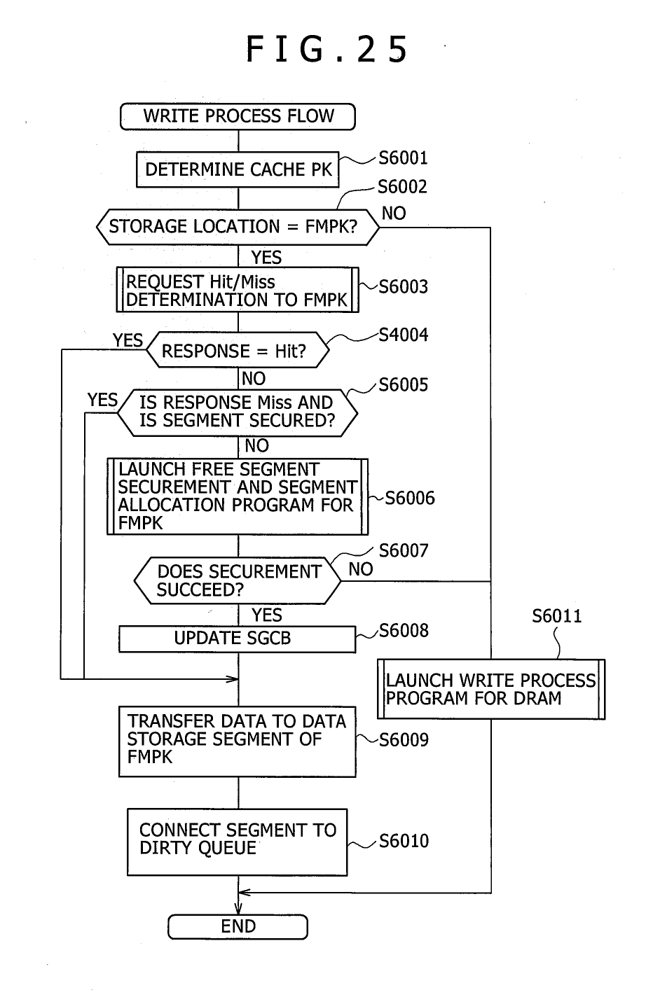

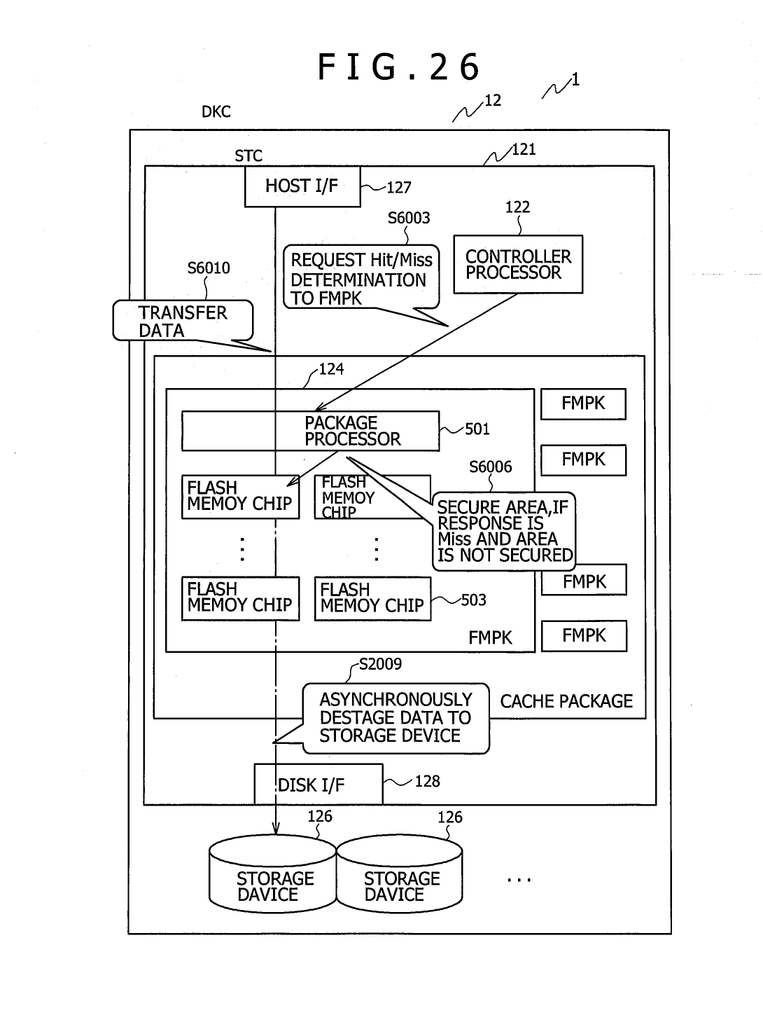

FIG. 25 is a flowchart of a write process program. FIG. 26 is a schematic view corresponding to a write I/O process program illustrated in FIG. 25.

This program is executed by the controller processor 122 when the controller processor 122 receives a write command from the host computer. First, the program interprets an access request from the host, determines the target volume number and logical address, and determines a storage location cache package of a write target data. For example, this determination may be determined based on the allocated location cache package determination process program illustrated in FIG. 17 or may be determined by referring to the allocated location cache package table illustrated in FIG. 17 (S6001). The flow from S6002 to S6008 is in common with the read process flow from S2002 to S2008 in FIG. 20, and therefore, description is skipped. This program launches the write process program for DRAM when the determination is No in S6002 (S6011). The program stores data to a data segment by assigning LBA# to FMPK 124 after the determination is determined to Yes in S6004 and S6005 or SGCB is updated in S6008 (S6009), and connects the segment to MRU in the dirty queue (S6010), and terminates. The controller processor 122 can executes other processes during from requesting the Hit/Miss determination to waiting the completion message of the Hit/Miss determination, and as a result, an operation rate of the processor can be increased.

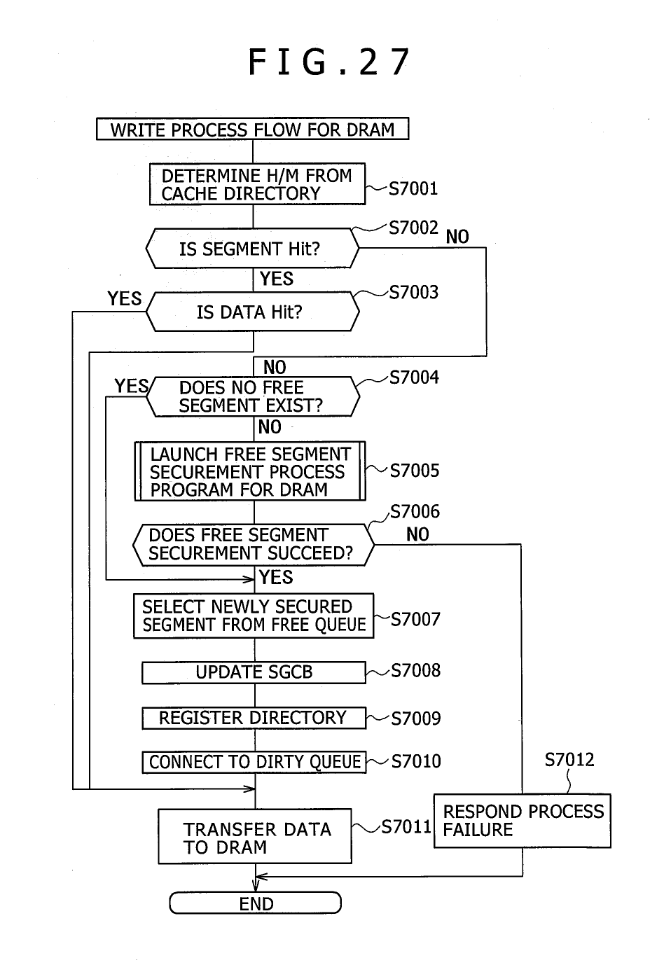

FIG. 27 is a flowchart of a write process flow for DRAM.

This program is executed by the controller processor 122. The difference between this program and the read process flow for DRAM in FIG. 20 is steps S7010 and S7011. Similar to S6010, S7010 is a process for connecting a segment to MRU of the dirty queue, and S7011 is a process for storing data to an allocated location segment of the aforementioned DRAM.

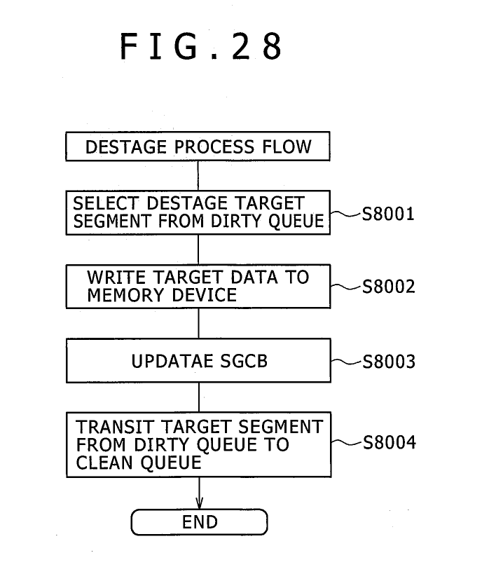

FIG. 28 is a flowchart of a destage process program.

This program is, for example, periodically executed by the storage controller processor 122. The program may be operated when a load of the processor 122 is low or an amount of dirty data in the cache package is larger than a constant ratio. First, the program selects a destage target segment by selecting the oldest segment in the dirty queue (S8001). Subsequently, this program transfers the target data from the aforementioned segment in DRAM 123 or FMPK 124 to the memory device (S8002). Subsequently, this program updates SGCB corresponding to the aforementioned segment (S8003). Specifically, this program changes the segment status to a clean status and sets a bit that indicates the destage target data of the dirty bit map. Subsequently, this program transits the target segment from the dirty queue to the clean queue and terminates the process (S8004).

### <Hit/Miss Determination Request and Process>

FIG. 29 is a flowchart of a Hit/Miss determination process program in FMPK 124. This program is launched by the controller processor when a cache package of the access location is FMPK 124 (S2003 in FIGS. 20 and 56003 in FIG. 25) and executed by the package processor of FMPK 124 responding to a request from the controller processor 122 to FMPK 124 ((1) and (2) in FIG. 13 and FIG. 14).

This program is called by the package processor with a logical volume number and a logical address included in the request message (FIG. 14). This program determines whether data is registered in the cache directory in the memory package or not in a manner that the program specifies a segment number by referring to a cache directory 513 for FMPK (FIG. 6 and FIG. 10) based on the logical volume number and the logical address included in the request message and determines the aforementioned segment (S9001). When the data is registered, this program responds the Hit result and the aforementioned segment number (FIG. 15) (S9007). If the data is not registered, the package processor of FMPK 124 determines whether a free segment exists or not (S9002). If the free segment exists, then this program selects the aforementioned free segment (S9003), registers the data to the cache directory for FMPK 124 in the package memory (S9004), and responds Miss, the result of success in segment allocation, and the allocated segment number (FIG. 15) (S9005). If the free segment does not exist in S9002, then this program responds Miss and the result of unallocation of the free segment (S9006). Although not illustrated in FIG. 29, the processor of FMPK 124 processes the Hit/Miss determination process in S9005, S9006, and S9007, and thereby requirement of process and communication with respect to the cache control process among the storage system, other flash memory package, and the like is reduced while the package processor processes the cache control process. As a result, the controller processor can execute other processes during processing the Hit/Miss determination by the package processor, and therefore, the throughput can be increased.

### <Addition and Deletion of FMPK>

It is presumed that the controller processor 122 has a status in which a problem does not occur even when all dirty data stored in the cache memory allocated to FMPK 124 at the timing of addition and deletion of FMPK 124 are deleted by destage. At this time, the target segment may be deleted from the directory if necessary and the dirty queue may be transited to the free queue. Thereafter, a method for determining FMPK 124 is changed so that FMPK 124 is newly and uniquely determined by logical volume address calculation.

The FMPK addition and deletion process program changes allocation of the logical volume address to FMPK corresponding to change in the number of installed FMPKs with addition and deletion of FMPK 124. This program is called by the controller processor 122 when FMPK 124 is added or deleted.

First, the storage system 12 is switched to an FMPK disabled mode in order to change the allocation. Specifically, the disabled mode can be achieved, for example, in a manner that an FMPK enabled flag is set on the control memory 125 and the flag is set to OFF, and then, the controller processor 122 determines whether FMPK is enabled or disabled with reference to this flag when the access request from the host computer is processed.

Subsequently, release of all segments is requested to all FMPKs. The controller processors in each FMPK that receives the request release the segments allocated to its own package memory. When data is improperly stored in the segment in which allocated location is changed, the same data on the logical volume are stored in plural FMPKs and this cause inconsistency. The purpose of the operation described above is to avoid this inconsistency. The release may be targeted to not all segments but only segments that change the allocation. In this case, however, segments that are changed from before the allocation change to after the allocation change are previously determined.

Finally, the mode is switched into a FMPK enabled mode. The mode can be switched by setting the flag, which is set to OFF in the previous step, ON.

Both of maximization of efficiency in use of the cache memory and load shearing of the process can be achieved by setting a ratio of area of LBA# allocated to each flash memory package to a size of each changed flash memory package as a volume ratio.

The first embodiment is described above.

According to this embodiment, not the controller processor 122 in the storage system but the package processor 501 installed in FMPK 124 can execute the control process of the cache memory, specifically, the Hit/Miss determination process. The controller possessor can execute other processes for the period when the controller possessor makes the package processor processes the Hit/Miss determination and can improve throughput.

The storage location of the control information with respect to data stored in FMPK 124 is characteristic. In other words, the storage location is characteristic in that the control information with respect to queue management (clean queue/dirty queue) is stored in the control memory 125 of the storage controller 121 and the cache directory is stored in the package memory 504 of FMPK 124. When the controlled target segments exist across plural flash memory packages, the controller processor executes the process by using control information with respect to queue management stored in the control memory 125 of the storage controller 121. On the contrary, when the controlled target segment is in a single flash memory package, the package processor existing in each FMPK 124 executes the process.

Specifically, a process that determines the flash memory package that is a storage target corresponding to a logical volume address and a process that selects a destage target segment are processes that are executed not depending on information of a cache directory for FMPK and a free queue for FMPK stored in the package memory of the flash memory package and that should be executed by the controller processor. The reason why the process for determining the flash memory package is a process that is required to be executed by the controller processor is because, when determination of the storage target flash memory package is executed by any package processors, in the case that FMPK 124 is unallocated to the logical volume address, subsequent process is accordingly required to be processed by transferring an execution body again to a package processor in FMPK 124 that is different from the target FMPK 124 or a controller processor (when the storage location is DRAM), and thus, the efficiency is reduced due to generation of communication overhead. Information required for this process (in this embodiment, no particular control information exists because determination of the target flash memory package is determined only by calculation, while this control information is relevant when other determination method (for example, a corresponding relation between the logical volume address and the target package number is stored in a table and controller processor refers to this corresponding relation) is employed) should be stored in the control memory. In the case of the latter destage process, reference to the dirty queue is required. The dirty data is, however, stored in different flash memory packages. Therefore, the process for selecting the destage target segment by searching the dirty queue should be a process executed by the controller processor. The dirty queue used at this time should be also stored in the control memory in the storage controller.

Examples of other information that should be stored in the control memory in the storage controller include access pattern learning information. For example, to previously carry out staging (look-ahead) and the like is possible by learning whether the access pattern from the host is random access or sequential access based on past access history and predicting access location included in a future access request based on the learning. The learning described above is required to be carried out across different segments, and therefore, control information (leaning information) used for the learning is stored in the control memory in the storage controller and the learning process should be executed by the controller processor.

As other information, stripe configuration information (location information of segments constituting the stripe) at the time of assembling RAID configuration and the like are control information across segments, and therefore, the information should be stored in the control memory in the storage controller.

As described above, by an effect in which the controller processor 122 executes the process executed across segments of plural flash memory packages, while whether a possessor executing the process is the controller processor 122 or the package processor 501 or not is determined based on whether the process is executed not across the segments of the flash memory packages is executed by the package processor or not, FMPK 124 can execute the Hit/Miss determination process, and thus, the controller processor 122 can executes other processes and the storage system 12 can be operated in a high rate.

A second embodiment is an embodiment in which SGCB is located in the package memory 510 in FMPK 124 for segments in FMPK 124.

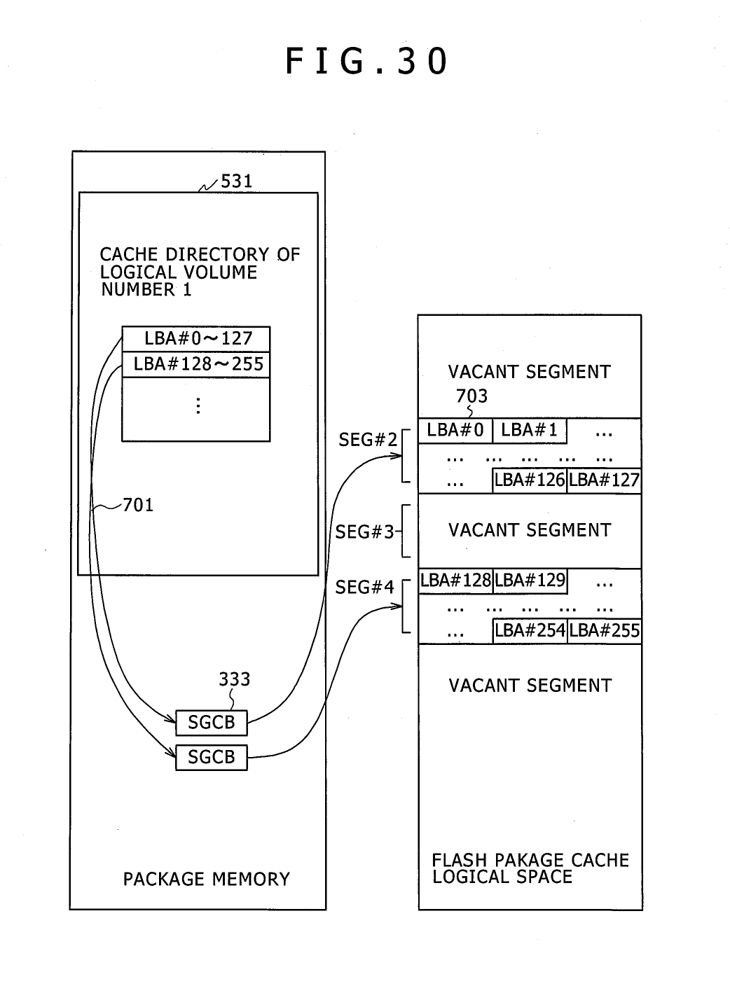

FIG. 30 is a configuration example of the cache directory and SGCB with respect to FMPK 124 in this embodiment. This configuration example is different from the embodiment 1 in that SGCB is located in the package memory 510. In this case, similar to the cache directory for DRAM 123, the cache directory for FMPK 124 memory may also directly point SGCB. In this case, however, the segment number should be stored because SGCB cannot directly be pointed from the queue entry of the clean queue/dirty queue in the control memory 125.

By this operation, the control memory 125 can have a smaller capacity and a cost can be reduced, because only queue management has only to be located in the control memory 125 in the storage system and SGCB having a relatively large ratio of capacity in the cache control information, particularly fine-graded dirty/clean status management information such as a staging bit map and a dirty bit map can be included in each FMPK 124 having a large capacity.

The third embodiment is an embodiment to which a logical volume address-physical address conversion table 613 made by integrating the physical address-logical address conversion table in FMPK 124 and the cache directory is added and in which this table is used. This table is located in the memory package.

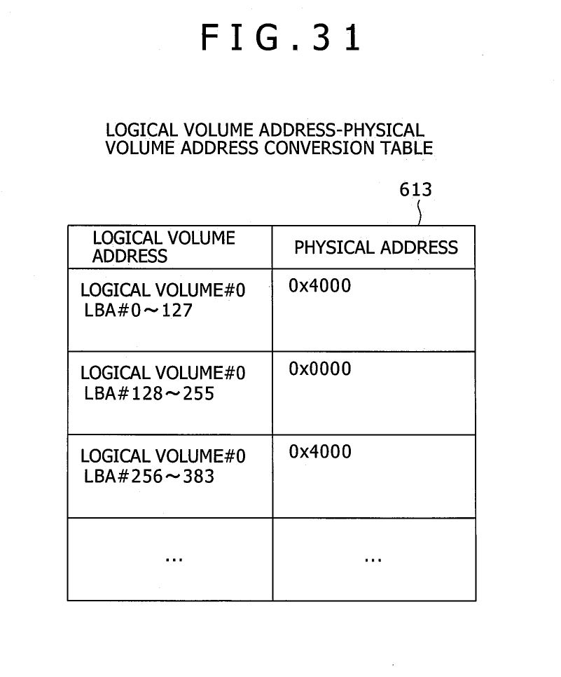

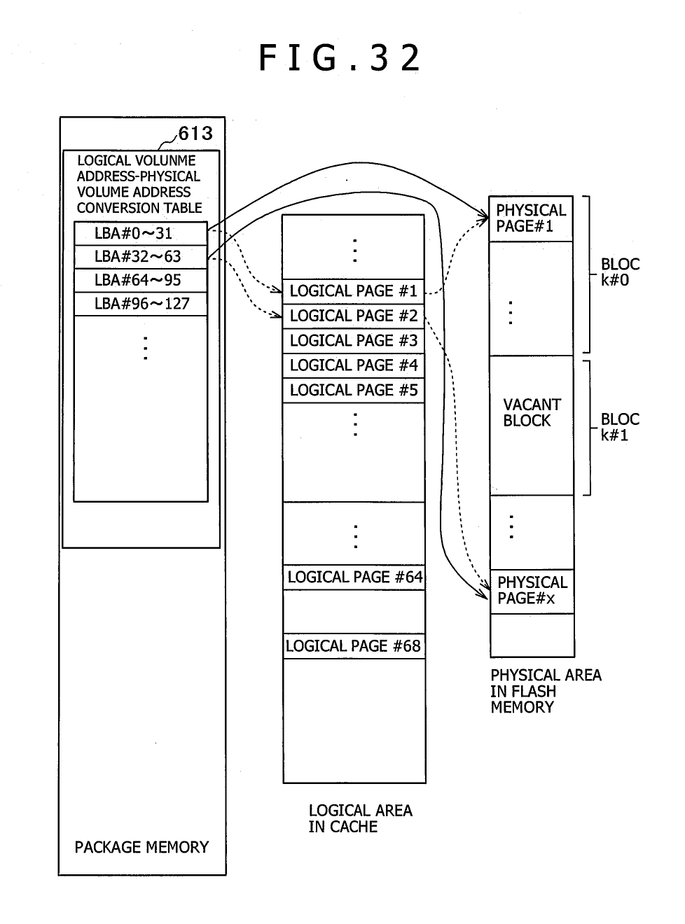

FIG. 31 is a view illustrating an example of logical volume address-physical address conversion table. The table is configured by a field storing the logical volume address and a field storing the physical address. At this time, however, an area of the logical volume address stored in the entry is required to be adjusted to an allocation unit of the physical address (a page unit in FMPK). By this operation, in the Hit/Miss determination process in the first embodiment and the second embodiment, the segment is calculated from the logical volume address, that is, the physical address is calculated by once converting the logical volume address to the address of the cache logical space, and then, carrying out the logical address-physical address conversion, while, in the third embodiment, conversion of the logical volume number and the logical address to the physical page can be carried out in one step as illustrated in FIG. 32 using the logical volume address-physical address conversion table in FIG. 31 in the case of determination to allocated segment (that is, in the case that the result is Hit). Thus calculated physical address is responded to the controller processor as a completion message of the Hit/Miss determination process. When the physical address is assigned by a succeeding transfer instruction to the host I/F, the conversion of logical address-physical address is not required at this time, and thus, process efficiency can be improved because the conversion process is carried out only once in total

A segment number in FMPK 124 can be matched to a page number by matching a page that is an allocation unit of the physical address in FMPK 124 and a size of the segment that is an allocation unit of stored data, and thus, process efficiency can be improved.

As described above, the embodiments of the present invention is described. The present invention, however, is not limited to each embodiment, and it goes without saying that various changes can be made without departing from the scope of the present invention.

1. A storage system comprising a cache package, the cache package including:
a memory device having a memory area;
a controller processor configured to issues a Hit/Miss determination request of a cache determining whether data being a target of an access request based on the access request, responding to the access request to the memory device from a host computer and to process the access request responding to a response to the Hit/Miss determination of the cache;
a memory chip temporarily storing data stored in the memory device; and
a package processor configured to receive the Hit/Miss determination request of the cache, to determine whether data specified based on address information indicating a stored location of the data on the memory device assigned by the Hit/Miss determination request of the cache is stored in the memory chip or not, and to respond an aforementioned determination result to the controller processor, wherein the controller processor changes the address information indicating a storage location of data on the storage device of each cache package based on an access status of the cache package and an access status of a cache package different from the cache package.

2.-11. (canceled)
